(19) United States
(12) Patent Application Publication
(10) Pub. No.: US 2007/0239492 A1
(43) Pub. Date: Oct. 11, 2007

(54) Estimating benefit plan costs

(76) Inventors: Christopher L. Sweetland, San Francisco, CA (US); Loren E. McCaghy JR., East Hampton, CT (US); Charles A. Nunn, Brooklyn, NY (US); Neville Q. Hamilton, Alameda, CA (US); Richard D. Cornelius, Telluride, CO (US)

Correspondence Address: FISH & RICHARDSON P.C., P.O. BOX 1022, MINNEAPOLIS, MN, 55440-1022, US

(21) Appl. No.: 11/401,735

(22) Filed: Apr. 10, 2006

(51) Int. Cl. G06Q 10/00; G06Q 40/00

(52) U.S. Cl. 705/4; 705/1; 705/2

(57) ABSTRACT

A method may aggregate historical transactions for a consumer, each transaction being associated with services or products provided to the consumer. Thereafter, one or more benefit plans available to the consumer are identified. These benefit plans (e.g., healthcare insurance plans) provide payment for predetermined services or products provided to the consumer. Costs that would be incurred by the consumer if the consumer used each of the identified one or more benefit plans for payment of the transactions are then determined. Based on this determination, data indicating costs associated with at least one benefit plan are transmitted. Related apparatuses, computer program products, and computer systems are also described.

### TECHNICAL FIELD

The subject matter described herein relates to estimating payments to be made by one or more payment sources, including benefit plans.

### BACKGROUND

There is an increasing trend for consumers to obtain more healthcare insurance coverage (as well as other benefit plans) than is necessary. Although the full extent of such coverage is rarely utilized by consumers, costs of employer-sponsored healthcare insurance plans are also increasing. These costs, in turn, are passed on to the employees (e.g., consumers). As a result, consumers are more carefully considering their various options when enrolling and renewing healthcare insurance coverage.

FIGS. 1-3 illustrate three conventional healthcare insurance plan arrangements. With reference to the process flow diagram 100 of FIG. 1, a consumer 110 receives healthcare/treatment from a provider 120 and, at step 115, pays a member cost share for the treatment (e.g., a relatively small co-pay, co-insurance deductible, etc.). Thereafter, the provider 120, at step 125, files a claim with a health plan 130 that, at step 135, reimburses provider 120 the amount covered as provided by the terms and conditions of the plan. The provider 120 may then, at step 145, bill the consumer 110 for any remaining uncovered costs of the treatment.

In an alternative arrangement, as illustrated in the process flow diagram 200 of FIG. 2, a consumer 210 may receive healthcare/treatment from a provider 220 and, at step 215, pay a portion (or all) of the costs of the treatment. The provider 220 may then, at step 225, file a claim with the health plan 230 for payment for the treatment, and the consumer 210 may then, at step 235, separately file a claim with the health plan 230 for reimbursement of any payments.

With reference to the process flow diagram 300 of FIG. 3, another variation is provided in which a consumer 310 receives healthcare/treatment from provider 320 and, at step 315, pays a significant portion (or all) of the cost of the treatment (co-pay, co-insurance, deductible, etc.) directly to the provider 320. The provider 320, at step 325, files a claim with a health plan 330 of the consumer 310 that may, in turn, at step 335, pay the provider 320 the full amount specified in the filed claim or a portion thereof. In addition, the consumer 310 may, at step 345, draw from funds from a financial institution 340 equal to all or a portion of the amount paid by the consumer 310 out-of-pocket for the treatment. The financial institution 340 may manage or operate tax-advantaged, health specific spending accounts (e.g., FSA—flexible spending accounts, HRA—health reimbursement accounts, HSA—health savings accounts, etc.) that may be used for qualified healthcare treatments/prescriptions.

Based on the complexity of the various healthcare insurance options (as well as other benefit plans) and their associated coverage policies, consumers tend to be ill-equipped to select an optimal plan for their particular situation. Determining reimbursement eligibility for certain types of treatments or products requires in-depth analysis and understanding of the various healthcare insurance plans. As a result, consumers typically select a healthcare insurance plan with a manageable out-of-pocket fixed monthly cost which does not necessarily result in optimal cost savings.

### SUMMARY

In one aspect, a method includes aggregating historical transactions for a consumer. Each of the transactions is associated with either a service or product provided to the consumer. One or more benefit plans (e.g., insurance plans, etc.) available to the consumer are automatically identified. These benefit plans provide payment for predetermined services and/or products provided to the consumer. Thereafter, for each identified benefit plan, a cost that would be incurred by the consumer if the consumer used the benefit plan for payment of the transactions is determined. Once the costs have been determined, data indicating costs associated with at least one benefit plan is transmitted.

In some variations, the method may also include automatically identifying one or more benefit plan spending accounts (e.g., healthcare spending accounts, etc.) available to the consumer to draw upon for payment of predetermined services or products provided to the consumer, and automatically determining costs that would be incurred by the consumer if the consumer had drawn from the identified one or more benefit plans savings accounts for payment of the transactions. In addition, the method may provide that the transmitted data comprises costs associated with the one or more benefit plan requiring the least out-of-pocket costs to the consumer and/or an estimation of a portion of the transaction not covered by the benefit plan and/or an estimation of a portion of the transaction covered by a benefit plan spending account.

In yet other variations, the method may determine costs that would be incurred by the consumer by associating each aggregated historical transaction with a benefit category (each having an associated benefit level), and estimating, for each benefit category, a payment amount that will not be covered by the benefit plan.

After the data is transmitted the method may also include receiving a request (from a module associated with the consumer) selecting one or more of the benefit plans. Thereafter, in response to the received request, identification data associated with the consumer may be transmitted to one or more network nodes associated with the selected one or more benefit plans.

The method may also comprise associating a credit rating with the consumer, and excluding identified benefit plans requiring a consumer credit rating higher than the associated credit rating. In some variations, the method retrieves the historical transactions of the consumer from a data repository. In other variations, the historical transactions are obtained by polling one or more benefit plans and/or service providers associated with the consumer. In still other variations, the method presents the consumer with a series of interrogatories in a graphical user interface to collect the historical transactions.

In another aspect, an apparatus includes an aggregation unit, a determination unit, and a transmission unit. The aggregation unit is operable to aggregate historical transactions for a consumer, each transaction being associated with services or products provided to the consumer. The determination unit is operable to identify one or more benefit plans available to the consumer, the benefit plans providing payment for predetermined services or products provided to the consumer. The determination unit is also operable to determine, for each identified benefit plan, a cost that would be incurred by the consumer if the consumer used the benefit plan for payment of the transactions. The transmission unit is operable to transmit data indicating costs associated with at least one benefit plan.

In yet another aspect, an interrelated method includes obtaining historical medical data for a consumer. This obtained medical data is automatically associated with a health care requirements profile that identifies predicted healthcare requirements for the consumer based on one or more individuals having medical data analogous to the obtained medical data. One or more benefit plans available to the consumer are identified. These benefit plans provide payment for predetermined healthcare services or products provided to the consumer. Thereafter, for each identified benefit plan, a cost that would be incurred by the consumer if the consumer used each of the identified one or more benefit plans for payment of expenses associated with the predicted healthcare requirements is automatically determined. Data indicating costs associated with at least one benefit plan are then transmitted.

In still another aspect, an interrelated apparatus may comprise an acquisition unit, an association unit, a determination unit, and a transmission unit. The acquisition unit is operable to obtain historical medical data for a consumer. The association unit is operable to associate the obtained medical data with a health care requirements profile that identifies predicted healthcare requirements for the consumer based on one or more individuals having medical data analogous to the consumer medical data. The determination unit is operable to identify one or more benefit plans available to the consumer. These benefit plans provide payment for predetermined healthcare services or products provided to the consumer. The determination unit is also operable to determine, for each identified benefit plan, costs that would be incurred by the consumer if the consumer used the benefit plan for payment of expenses associated with the predicted healthcare requirements. The transmission unit is operable to transmit data indicating costs associated with at least one benefit plan.

In another interrelated aspect, a method may comprise obtaining at least one of aggregated historical transactions or predicted transactions for a consumer, each transaction being associated with services or products provided to the consumer, automatically identifying one or more payment sources available to the consumer, the payment sources providing payment for predetermined services or products provided to the consumer, automatically determining, for each identified payment source, a cost that would be incurred by the consumer if the consumer used each of the identified one or more payment sources for payment of the transactions, and transmitting data indicating costs associated with at least one payment source.

Computer program products, which may be embodied on computer readable-material, are also described. Such computer program products may include executable instructions that cause a computer system to conduct one or more of the method acts described herein.

Similarly, computer systems are also described that may include a processor and a memory coupled to the processor. The memory may encode one or more programs that cause the processor to perform one or more of the method acts described herein.

The subject matter described herein may provide any of several advantages. For example, the estimation techniques described herein allow a consumer to make an informed choice when selecting whether or not to sign up for a benefit plan by providing expected costs associated with one or more available benefit plans. These estimates may result in the consumer funding more expenses out-of-pocket which can result in reduced benefit plan costs for an employer. Moreover, the subject matter described herein may generate additional sales leads for benefit plans, service providers, financial institutions and the like by providing recommendations to consumers.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a first healthcare insurance arrangement;

FIG. 2 is a process flow diagram illustrating a second healthcare insurance arrangement;

FIG. 3 is a process flow diagram illustrating a third healthcare insurance arrangement;

FIG. 4 is a process flow diagram illustrating a first method for estimating costs associated with one or more benefit plans;

FIG. 5 is a process flow diagram illustrating a second interrelated method for estimating costs associated with one or more benefit plans;

FIG. 6 illustrates a schematic diagram of a first apparatus to estimate costs associated with one or more benefit plans;

FIG. 7 illustrates a schematic diagram of a second interrelated apparatus to estimate costs associated with one or more benefit plans; and

FIG. 8 illustrates a schematic diagram of an apparatus useful for understanding and implementing the subject matter described herein.

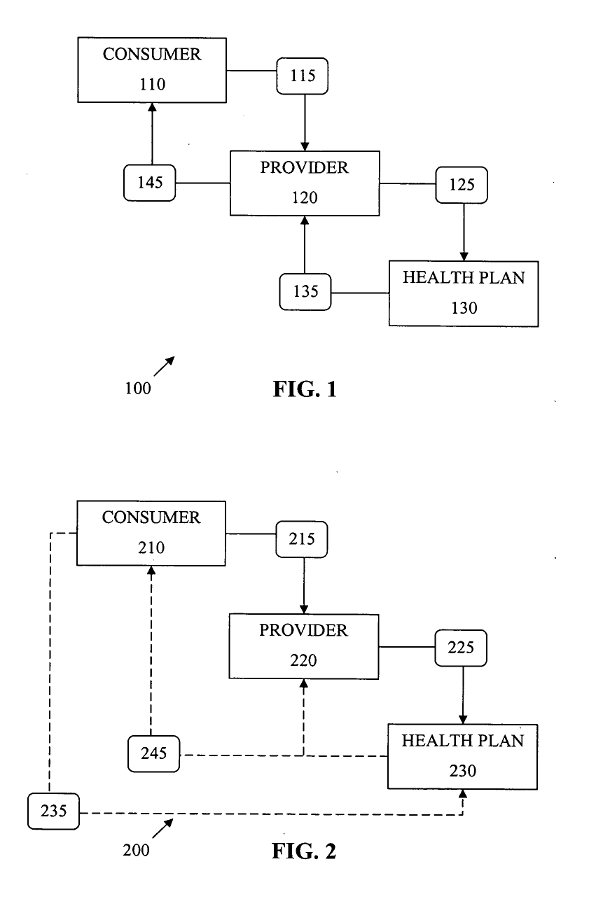

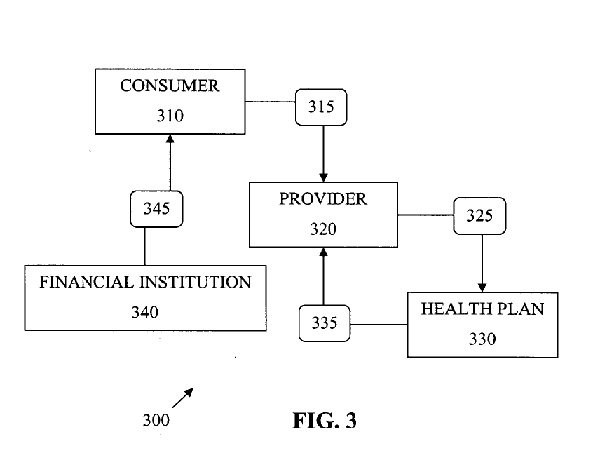

### DETAILED DESCRIPTION

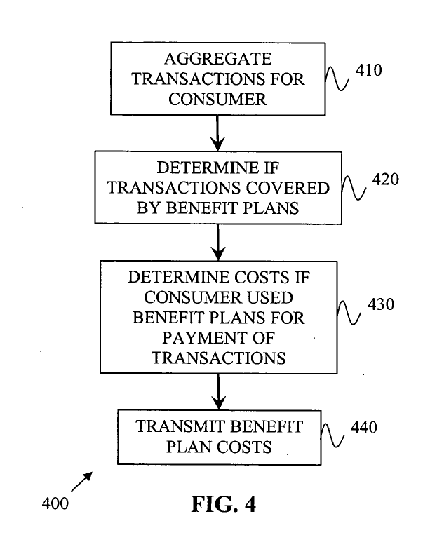

FIG. 4 illustrates a method 400 in which, at step 410, historical transactions for a consumer are aggregated (or otherwise obtained). Each of these transactions is associated with services and/or products provided to the consumer. At step 420, one or more benefit plans available to the consumer are identified. The benefit plans are any sort of financial arrangement that provides payment for predetermined services or products provided to the consumer. Thereafter, at step 430, costs that would be incurred by the consumer if the consumer used each of the identified one or more benefit plans for payment of the transactions are determined. Based on this determination, at step 440, data indicating costs associated with at least one benefit plan is transmitted.

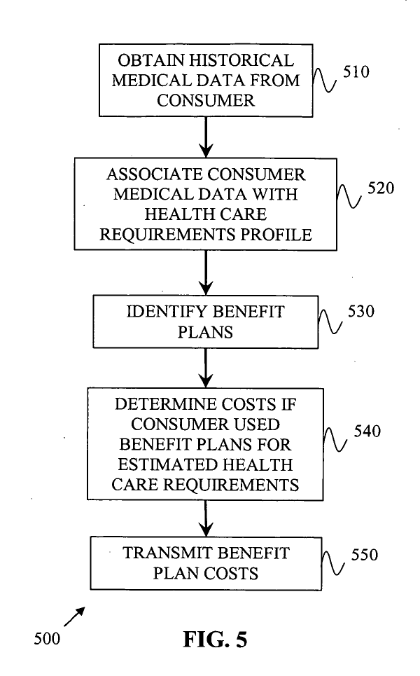

With reference to FIG. 5, a method 500 is illustrated that is interrelated to that of FIG. 4. This method 500, at step 510, obtains historical medical data for a consumer. This obtained medical data, at step 520 is associated with a health care requirements profile. The health care requirements profile identifies (or otherwise includes) predicted healthcare requirements for the consumer based on one or more individuals having medical data analogous to the obtained medical data. At step 530, one or more benefit plans available to the consumer are identified. Such benefit plans may, subject to eligibility, provide payment for predetermined healthcare services or products provided to the consumer. Thereafter, at step 540, costs that would be incurred by the consumer if the consumer used each of the identified one or more benefit plans for payment of expenses associated with the predicted healthcare requirements are determined. Subsequent to such determination, at step 550, data indicating costs associated with at least one benefit plan may be transmitted.

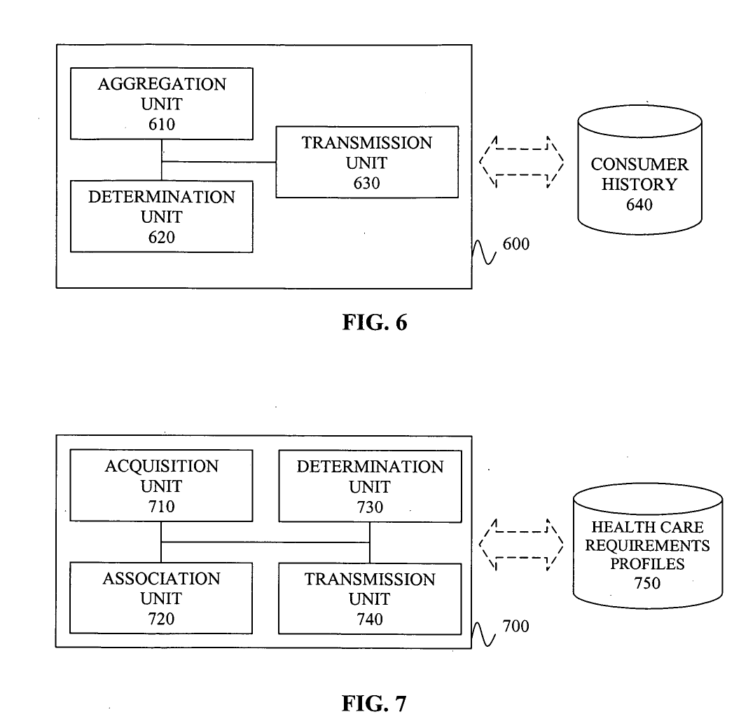

FIG. 6 illustrates an apparatus 600 that comprises an aggregation unit 610, a determination unit 620, and a transmission unit 630. The aggregation unit 610 is operable to aggregate historical transactions for a consumer, each transaction being associated with services or products provided to the consumer. The determination unit 620 is operable to identify one or more benefit plans available to the consumer, the benefit plans providing payment for predetermined services or products provided to the consumer. The determination unit 620 is also operable to determine costs that would be incurred by the consumer if the consumer used each of the identified one or more benefit plans for payment of the transactions. The transmission unit 630 is operable to transmit data indicating costs associated with at least one benefit plan. Optionally, the apparatus 600 may be coupled to or include a consumer history data repository 640 that includes information pertaining to the historical transactions for the consumer.

With reference to FIG. 7, an apparatus 700, which is interrelated to the apparatus 600 of FIG. 6 is illustrated. This apparatus 700 includes an acquisition unit 710, an association unit 720, a determination unit 730, and a transmission unit 740. The acquisition unit 710 is operable to obtain historical medical data for a consumer. The association unit 720 is operable to associate the obtained medical data with a health care requirements profile. With this arrangement, the health care requirements profile identifies predicted or expected healthcare requirements for the consumer based on one or more individuals (and/or records associated therewith) having medical data analogous to the consumer medical data. The determination unit 730 is operable to identify one or more benefit plans available to the consumer that provide payment for predetermined healthcare services or products provided to the consumer. The determination unit 730 is also operable to determine costs that would have be by the consumer if the consumer used each of the identified one or more benefit plans for payment of expenses associated with the predicted healthcare requirements. The transmission unit 740 is operable to indicate costs associated with at least one benefit plan. Optionally, the apparatus 700 may be coupled to or include a health care requirements profile data repository 750 that includes information pertaining to the associated health care requirements profile.

The following provides useful information for understanding and implementing the subject matter described herein as well as optional variations that may be implemented singly or in combination depending on the desired configuration.

As used herein, the terms consumer may refer to an individual or other entity that may or may not be affiliated with any benefit plans or other payment sources. In addition, the term provider as used herein describes both entities providing services (e.g., medical doctors, medical groups, leasing companies, etc.) as well as those selling or leasing products (e.g., pharmacies, medical equipment leasing companies, etc.).

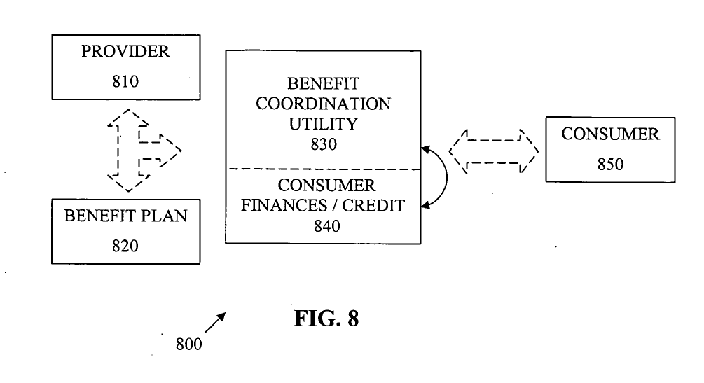

FIG. 8 illustrates a system 800 in which at least one provider module 810 associated with a service provider (e.g., doctor, pharmacist, medical equipment leasing company, etc.) is coupled to via a network to at least one benefit plan module 820. Both of the provider module 810 and the benefit plan module 820 may in turn, be coupled to a benefit coordination utility 830. In some variations, the benefit coordination utility 830 also includes or is coupled to one or more network nodes associated with consumer finances/credit module 840. The benefit coordination utility 830 may also be coupled to or operate to transmit data to a consumer module 850 associated with a consumer. Each of the modules may comprise network nodes which are coupled to each other via a network or a series of networks.

The benefit coordination utility 830 may be an intermediary that acts to handle and otherwise process requests for benefit plan (e.g., healthcare insurance) payments/coverage. One such benefit coordination utility is described in U.S. patent application No. ______ entitled “Benefit Plan Intermediary” filed concurrently herewith, the contents of which are hereby incorporated by reference. The benefit coordination utility 830 may alternatively comprise a recommendation engine that obtains relevant information by polling or otherwise obtaining information from one or more of the provider module 810, benefit plan module 820, and optionally the consumer module 850 in order to predict or estimate costs to the consumer associated with one or more benefit plans.

The benefit coordination utility 830 is operable to obtain relevant background information (e.g., medical data) of the consumer. In one variation, the benefit coordination utility 830 has stored, in a data repository, all of the claims made against a benefit plan over a specified period of time (e.g., the previous year) (each of such claims being a historical transaction). In another variation, the benefit coordination utility 830 may poll one or more provider modules 810 in order to obtain relevant information characterizing any transactions that involved the consumer over a predetermined period of time. Similarly, the benefit coordination utility may poll one or more of the benefit plan modules 820 to obtain information characterizing any claims that involved the consumer over a predetermined period of time. Optionally, the benefit coordination utility 830 may obtain the relevant background information after a consumer enters in all of his or her transactions into a graphical user interface on, for example, the consumer module 850.

In another variation pertaining to healthcare insurance, relevant background information may be based on medical history (which includes current medical condition) of the consumer. The medical history may be obtained from a data repository (e.g., database, healthcare history data storage device, etc.), it may be obtained directly from the consumer using a graphical interface in the consumer module 850, and/or it may be obtained from one or more provider modules 810. In the latter arrangement, a wizard process may be initiated on a computer display associated with the consumer module 850 that presents the consumer with a series of interrogatories in a graphical user interface. These interrogatories may present questions similar to those found on a life insurance medical questionnaire. Other input mechanisms may be used to obtain the consumer medical data.

With those variations using medical history information from the consumer, the obtained medical history information must be mapped or otherwise associated with a healthcare requirements profile. This healthcare requirements profile identifies expected or predicted healthcare requirements/transactions (referred to as predicted transactions) for the consumer and may be based on one or more individuals that have medical data analogous or identical to the consumer's medical data. For example, medical data including gender, family history, race, number of doctor visits and reasons for such visits, hospital stays, treatments, prescription needs, and the like over a period of several years are obtained from a plurality of individuals. The mapping process takes the age of the consumer and his or her historical medical history and finds one or more of the individuals that have the same or similar medical data for someone with a similar background (e.g., age, gender, and possibly other factors such as race (which can affect health)). Actuarial data and other related information may also, or alternatively, be used to construct the healthcare requirements profile.

Using either the historical or the predicted transactions, the benefit coordination utility 830 determines whether any payment sources will cover either the historical transactions or predicted. For example, the benefit coordination utility 830 may identify benefit plans (e.g., different coverage options under an employer-sponsored insurance plan) available to the consumer and determine whether such benefit plans would cover the historical or predicted transactions (as the case may be) and to what extent such plans would provide coverage. This determination may be based on coverage guideline information provided to the benefit coordination utility 830 or the benefit coordination utility 830 may poll one or more of the benefit plan modules 82.

In some variations, some of the benefit plans may require a certain credit rating or a minimum bank account balance (as determined by the consumer finances/credit module 840) for the consumer and may be excluded on this basis. Optionally, the benefit coordination utility 830 may also determine whether there are any available secondary payment sources such as benefit spending accounts from which a consumer may draw upon for payment or reimbursement of the historical or predicted transactions.

After the benefit coordination utility 830 has determined what portion of the historical or predicted transactions would be covered by the benefit plans, then it may transmit data to the consumer module 850 indicating the total costs associated with each benefit plan (including any employer-covered portions) and/or it may indicate the estimated out-of-pocket expenses for the consumer for each of the benefit plans. The benefit coordination utility 830 may also or alternatively transmit data indicating the out-of-pocket expenses for the consumer if he or she had used one or more benefit spending accounts (which may take into account any associated tax benefits) as well as the amounts covered by such benefit spending accounts.

After the data is transmitted, the consumer may select one of the benefit plans through the consumer module 850 which in turns sends a request which may identify the consumer (e.g., name, address, personal identification number, etc.) to the benefit coordination utility 830. The benefit coordination utility 830 may then forward the request to the benefit plan module 820 so that the consumer may be enrolled in the selected benefit plan and/or obtain further information regarding the selected benefit plan.

The benefit coordination utility 830 may also transmit data (e.g., an e-mail message or a customized web page) to the consumer module 850 which includes recommendations for service providers, benefit plans, financial institutions selling benefit spending accounts, and the like. These recommended entities may be charged a fee per recommendation and/or a fee for each click-thru.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, while the foregoing primarily refers to medical/health benefit plans, the subject matter described herein may also be applied to other types of benefit plan/insurance coverage (including repair of insured automobiles after accidents, repairs of dwellings covered by homeowners insurance, etc.). Other embodiments may be within the scope of the following claims.

What is claimed is:

1. A computer-implemented method comprising:
aggregating historical transactions for a consumer, each transaction being associated with services or products provided to the consumer;
automatically identifying one or more benefit plans available to the consumer, the benefit plans providing payment for predetermined services or products provided to the consumer;
automatically determining, for each identified benefit plan, a cost that would be incurred by the consumer if the consumer used the benefit plan for payment of the transactions; and
transmitting data indicating costs associated with at least one benefit plan.

2. A method as in claim 1, further comprising:
automatically identifying one or more benefit plan spending accounts available to the consumer to draw upon for payment of predetermined services or products provided to the consumer; and
automatically determining costs that would be incurred by the consumer if the consumer had drawn from the identified one or more benefit plans savings accounts for payment of the transactions.

3. A method as in claim 1, wherein the transmitted data comprises costs associated with the one or more benefit plan requiring the least out-of-pocket costs to the consumer.

4. A method as in claim 1, wherein the transmitted data comprises an estimation of a portion of the transaction not covered by the benefit plan.

5. A method as in claim 1, wherein the transmitted data comprises an estimation of a portion of the transaction covered by a benefit plan spending account.

6. A method as in claim 1, wherein determining costs that would be incurred by the consumer further comprises:
associating each aggregated historical transaction with a benefit category, each benefit category having an associated benefit level; and
estimating, for each benefit category, a payment amount that will not be covered by the benefit plan.

7. A method as in claim 1, further comprising: receiving, in response to the transmitted data, a request selecting one or more of the benefit plans.

8. A method as in claim 7, further comprising: transmitting, in response to the received request, identification data associated with the consumer to one or more network nodes associated with the selected one or more benefit plans.

9. A method as in claim 1, further comprising associating a credit rating with the consumer; and excluding identified benefit plans requiring a consumer credit rating higher than the associated credit rating.

10. A method as in claim 1, further comprising: retrieving the historical transactions of the consumer from a data repository.

11. A method as in claim 1, further comprising: presenting the consumer with a series of interrogatories in a graphical user interface to collect the historical transactions.

12. An apparatus comprising:
an aggregation unit to aggregate historical transactions for a consumer, each transaction being associated with services or products provided to the consumer;
a determination unit to identify one or more benefit plans available to the consumer, the benefit plans providing payment for predetermined services or products provided to the consumer, and to determine, for each identified benefit plan, a cost that would be incurred by the consumer if the consumer used the benefit plan for payment of the transactions; and
a transmission unit to transmit data indicating costs associated with at least one benefit plan.

13. A computer program product, embodied on computer readable-material, said computer program product including executable instructions causing a computer system to conduct one or more of operations comprising:
aggregate historical transactions for a consumer, each transaction being associated with services or products provided to the consumer;
identify one or more benefit plans available to the consumer, the benefit plans providing payment for predetermined services or products provided to the consumer;
determine, for each identified benefit plan, a cost that would be incurred by the consumer if the consumer used the benefit plan for payment of the transactions; and
transmit data indicating costs associated with at least one benefit plan.

14. A computer-implemented method comprising:
obtaining historical medical data for a consumer;
automatically associating the obtained medical data with a health care requirements profile, the health care requirements profile identifying predicted healthcare requirements for the consumer based on one or more individuals having medical data analogous to the obtained medical data;
automatically identifying one or more benefit plans available to the consumer, the benefit plans providing payment for predetermined healthcare services or products provided to the consumer;
automatically determining, for each identified benefit plan, a cost that would be incurred by the consumer if the consumer used the benefit plan for payment of expenses associated with the predicted healthcare requirements; and
transmitting data indicating costs associated with at least one benefit plan.

15. A method as in claim 14, further comprising:
automatically identifying one or more benefit plan spending accounts available to the consumer to draw upon for payment of predetermined services or products provided to the consumer; and
automatically determining costs that would be incurred by the consumer if the consumer had drawn from the identified one or more benefit plans savings accounts for payment of expenses associated with the predicted healthcare requirements.

16. A method as in claim 14, wherein the transmitted data comprises costs associated with the one or more benefit plan requiring the least out-of-pocket costs to the consumer.

17. A method as in claim 14, wherein the transmitted data comprises an estimation of a portion of the transaction not covered by the benefit plan.

18. A method as in claim 14, wherein the transmitted data comprises an estimation of a portion of the transaction covered by a benefit plan spending account.

19. A method as in claim 14, wherein determining costs that would be incurred by the consumer further comprises:
associating each predicted healthcare requirement with a benefit category, each benefit category having an associated benefit level; and
estimating, for each benefit category, a payment amount that will not be covered by the benefit plan.

20. A method as in claim 14, further comprising: receiving, in response to the transmitted data, a request selecting one or more of the benefit plans.

21. A method as in claim 20, further comprising: transmitting, in response to the received request, identification data associated with the consumer to one or more network nodes associated with the selected one or more benefit plans.

22. A method as in claim 24, further comprising associating a credit rating with the consumer; and excluding identified benefit plans requiring a consumer credit rating higher than the associated credit rating.

23. A method as in claim 14, wherein the obtaining comprises: retrieving the medical data of the consumer from a data repository.

24. A method as in claim 14, wherein the obtaining comprises: presenting the consumer with a series of interrogatories in a graphical user interface to collect the medical data.

25. An apparatus comprising:
an acquisition unit to obtain historical medical data for a consumer;
an association unit to associate the obtained medical data with a health care requirements profile, the health care requirements profile identifying predicted healthcare requirements for the consumer based on one or more individuals having medical data analogous to the consumer medical data;
a determination unit to identify one or more benefit plans available to the consumer, the benefit plans providing payment for predetermined healthcare services or products provided to the consumer, and to determine, for each identified benefit plan, a cost that would be incurred by the consumer if the consumer used the benefit plan for payment of expenses associated with the predicted healthcare requirements; and
a transmission unit to transmit data indicating costs associated with at least one benefit plan.

26. A computer program product, embodied on computer readable-material, said computer program product including executable instructions causing a computer system to conduct one or more of operations comprising:
obtain historical medical data for a consumer;
associate the obtained medical data with a health care requirements profile, the health care requirements profile identifying predicted healthcare requirements for the consumer based on one or more individuals having medical data analogous to the consumer medical data;
identify one or more benefit plans available to the consumer, the benefit plans providing payment for predetermined healthcare services or products provided to the consumer;
determine, for each identified benefit plan, a cost that would be incurred by the consumer if the consumer used the benefit plan for payment of expenses associated with the predicted healthcare requirements; and
transmit data indicating costs associated with at least one benefit plan.

27. A computer-implemented method comprising:
obtaining at least one of aggregated historical transactions or predicted transactions for a consumer, each transaction being associated with services or products provided to the consumer;
automatically identifying one or more payment sources available to the consumer, the payment sources providing payment for predetermined services or products provided to the consumer;
automatically determining, for each identified payment source, a cost that would be incurred by the consumer if the consumer used the payment source for payment of the transactions; and
transmitting data indicating costs associated with at least one payment source.
